(19) United States
(12) Patent Application Publication
(10) Pub. No.: US 2026/0211975 A1
(43) Pub. Date: Jul. 23, 2026

(54) Gradient Based Optimization of Chaogates

(71) Applicant: North Carolina State University, Raleigh, NC (US)

(72) Inventors: William Lawrence Ditto, Raleigh, NC (US); Anil Radhakrishnan, Raleigh, NC (US)

(21) Appl. No.: 19/454,849

(22) Filed: Jan. 21, 2026

Related U.S. Application Data
(60) Provisional application No. 63/747,516, filed on Jan. 21, 2025.

(51) Int. Cl. G06F 17/18

(52) U.S. Cl. CPC G06F 17/18

(57) ABSTRACT

Various examples are provided related to chaogates. In one example, a method for chaogate configuration includes initializing chaogate parameters of a chaogate; determining binary cross-entropy losses based upon outputs of the chaogate with the initialized chaogate parameters and a truth table of desired Boolean outputs; adjusting chaogate parameters using stochastic gradient descent, the chaogate parameters negatively adjusted based upon a total loss and a defined learning rate; determining binary cross-entropy losses based upon outputs of the chaogate with the adjusted chaogate parameters and the truth table; repeating the adjustment of the chaogate parameters using stochastic gradient descent and the determination of the binary cross-entropy losses based upon outputs of the chaogate with the adjusted chaogate parameters and the truth table for a defined number of iterations or until the total loss is less than a defined threshold; and implementing a chaogate with the adjusted chaogate parameters.

### CROSS REFERENCE TO RELATED APPLICATIONS

This application claims priority to, and the benefit of, U.S. provisional application entitled “Gradient Based Optimization of Chaogates” having Ser. No. 63/747,516, filed Jan. 21, 2025, which is hereby incorporated by reference in its entirety.

### BACKGROUND

Modern digital computation is fundamentally built on Boolean logic, where basic operations are performed using deterministic logic gates. While this deterministic approach has proven effective, it inherently limits the system's flexibility and adaptability in dynamic, nonlinear environments. To address these limitations, researchers have explored the use of nonlinear systems, particularly chaotic dynamics, to create alternative logic gates, often referred to as Chaogates.

### SUMMARY

Aspects of the present disclosure are related to Chaogates, including their optimization and implementation. A method for configuring chaogates to replicate standard Boolean logic gate behavior using gradient-based optimization is presented. By defining a differentiable formulation of the chaogate encoding, its tunable parameters can be optimized to reconfigure the chaogate for standard logic gate functions. This approach can be further extended to the simultaneous optimization of multiple gates for tuning logic circuits. Experimental results demonstrate the viability of this technique across different nonlinear systems and configurations, offering a pathway to automate parameter discovery for nonlinear computational devices and chaogates.

This methodology can also utilize AI to configure morphable hardware based upon chaos and nonlinear dynamics. This is a breakthrough in making morphable circuits practical to supercharge AI systems as it holds out the possibility of morphing from gates to CPU, GPU, NPU and analog computers simply by using a chatGPT like command structure to change hardware to optimize AI functions thus addressing the need for higher precision, higher computation but with lower energy and computational resources.

In one aspect, among others, a method for chaogate configuration as a Boolean logic gate comprises initializing chaogate parameters of a chaogate; determining binary cross-entropy losses based upon outputs of the chaogate with the initialized chaogate parameters and a truth table of desired Boolean outputs; adjusting chaogate parameters using stochastic gradient descent, the chaogate parameters negatively adjusted based upon a total loss and a defined learning rate; determining binary cross-entropy losses based upon outputs of the chaogate with the adjusted chaogate parameters and the truth table; repeating the adjustment of the chaogate parameters using stochastic gradient descent and the determination of the binary cross-entropy losses based upon outputs of the chaogate with the adjusted chaogate parameters and the truth table for a defined number of iterations or until the total loss is less than a defined threshold; and implementing a chaogate with the adjusted chaogate parameters. In one or more aspects, the total loss can be an average of all of the determined binary cross-entropy losses.

In various aspects, the method can comprise determining a negative gradient descent adjustment for each of the chaogate parameters based upon the total loss and the defined learning rate. The outputs of the chaogate can be passed through a sigmoid function prior to determining the binary cross-entropy losses. The chaogate can be a Logistic map, a Lorenz system, or a Duffing oscillator system. The Lorenz system or the Duffing oscillator system can be defined as a one-dimensional (1D) to 1D system. The Boolean logic gate is an AND gate, a NAND gate, a NOR gate, an OR gate, an XOR gate, or an XNOR gate. Implementing the chaogate can comprise reconfiguring an existing chaogate with the adjusted chaogate parameters.

In another aspect, a system for chaogate configuration as a Boolean logic gate comprises processing circuitry comprising a processor and memory; and machine-readable instructions stored in the memory that, when executed by the processor, cause the processing circuitry to at least: initialize chaogate parameters of a chaogate; determine binary cross-entropy losses based upon outputs of the chaogate with the initialized chaogate parameters and a truth table of desired Boolean outputs; adjust chaogate parameters using stochastic gradient descent, the chaogate parameters negatively adjusted based upon a total loss and a defined learning rate; determine binary cross-entropy losses based upon outputs of the chaogate with the adjusted chaogate parameters and the truth table; repeat the adjustment of the chaogate parameters using stochastic gradient descent and the determination of the binary cross-entropy losses based upon outputs of the chaogate with the adjusted chaogate parameters and the truth table for a defined number of iterations or until the total loss is less than a defined threshold; and implement a chaogate with the adjusted chaogate parameters. In one or more aspects, the total loss can be an average of all of the determined binary cross-entropy losses.

In various aspects, when executed, the machine-readable instructions can cause the processing circuitry to at least: determine a negative gradient descent adjustment for each of the chaogate parameters based upon the total loss and the defined learning rate. The outputs of the chaogate can be passed through a sigmoid function prior to determining the binary cross-entropy losses. The chaogate can be a Logistic map, a Lorenz system, or a Duffing oscillator system. The Lorenz system or the Duffing oscillator system can be defined as a one-dimensional (1D) to 1D system. The Boolean logic gate is an AND gate, a NAND gate, a NOR gate, an OR gate, an XOR gate, or an XNOR gate. Implementing the chaogate can comprise reconfiguring an existing chaogate with the adjusted chaogate parameters. The processing circuitry can comprise a computing device.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a schematic diagram illustrating an example of gradient based optimization of Chaogates, in accordance with various embodiments of the present disclosure.

FIG. 1B illustrates an example of an algorithm for gradient based optimization for Chaogate parameter tuning, in accordance with various embodiments of the present disclosure.

FIGS. 2-4 illustrate examples of tuning Chaogates with a Logistic map, a Lorenz system, and a Duffing system, respectively, in accordance with various embodiments of the present disclosure.

FIG. 5 includes Tables 1-3 showing examples of NAND and NOR Chaogate parameters for the Logistic map, in accordance with various embodiments of the present disclosure.

FIGS. 6A and 6B illustrate an example of simultaneous optimization of gates of a half adder, in accordance with various embodiments of the present disclosure.

FIG. 6C illustrates an example of an algorithm for simultaneous optimization of gates of a half adder, in accordance with various embodiments of the present disclosure.

FIG. 7 includes Table 4 showing an example of half adder Chaogate parameters, in accordance with various embodiments of the present disclosure.

FIGS. 8 and 9 illustrate examples of tuning Chaogates with a 2-dimensional Hénon map and a Logistic map, respectively, in accordance with various embodiments of the present disclosure.

FIG. 10 is a schematic diagram illustrating an example of processing circuitry for chaogate configuration and optimization, in accordance with various embodiments of the present disclosure.

### DETAILED DESCRIPTION

Disclosed herein are various examples related to Chaogates, including their optimization and implementation. Reference will now be made in detail to the description of the embodiments as illustrated in the drawings, wherein like reference numbers indicate like parts throughout the several views.

Chaogates exploit the rich repertoire of temporal patterns found in chaotic dynamics to perform logical operations. Chaogates, unlike their conventional counterparts, leverage analog signals and chaos theory to create dynamic gates capable of multiple logic functions. They offer advantages in reconfigurable computing and hold the potential to significantly enhance computational efficiency. Nonlinear systems such as the Logistic map, and the Lorenz and the Duffing oscillators, provide a mathematical basis for generating these chaotic dynamics. By carefully tuning the parameters of these maps, Chaogates can be configured to mimic the behavior of all traditional Boolean gates. The advantage of Chaogates lies in their reconfigurability and potential for flexibly performing more complex, nonlinear computations in a single device. Additionally, their sensitivity to initial conditions makes them less predictable. Combined with their reconfigurability, this unpredictability reduces the risk of side-channel attacks, making them well-suited for security-focused applications.

However, the challenge of finding the correct parameters to replicate standard gate functions is nontrivial due to the complex nature of the underlying maps. Traditional methods such as brute force searches or heuristic approaches often fail to efficiently explore the high-dimensional parameter space of these systems. This problem has been previously identified, and solutions have been proposed using Bayesian Optimization and Genetic Algorithms on three transistor Chaogates and it has been noted that “AI-based techniques stalled because it was not possible to develop a smooth accurate model of the transistor as a function of transistor parameters without expending substantial computational resources if at all.” The differentiable encoding with gradient-based optimization offers a promising solution.

This disclosure presents a novel methodology for using gradient-based optimization to configure nonlinear Chaogates. The focus is on Chaogates built using nonlinear chaotic maps to replicate the behavior of basic Boolean logic gates. By employing gradient descent and related optimization techniques, the parameters of these nonlinear systems can be efficiently tuned, achieving precise control over their logical behavior.

This work includes:
A gradient-based optimization framework for tuning chaotic systems to match predefined logic gate behavior.
Extension of the framework to show simultaneous optimization of multiple logic gates for logic circuits like the Half Adder.
A demonstration and comparison of the reconfigurability of Chaogates across nonlinear map configurations, showing the efficacy of using the same nonlinear system to perform multiple gate operations through parameter tuning.

In the following, an in-depth review of nonlinear maps and their use in logic gate design, detail the gradient-based optimization process, and present experimental results demonstrating the successful replication of Boolean gate functions through Chaogate configurations are provided. This approach opens the door to automating the use of Chaogates in novel computing paradigms, offering new pathways for dynamic and reconfigurable logic systems and furthering the application of nonlinear dynamics in real circuits.

### Chaogates

Boolean logic is the language of 1's and 0's all of modern computation is built on. The basic two-input logic gates (AND, OR, NAND, NOR, XOR, XNOR) all take in two inputs of TRUE(1) or FALSE(0) and return a similar Boolean output.

These gates can be obtained from any sufficiently controlled nonlinear system, and reconfigurable nonlinear processing devices can be constructed based on such gates. Specifically, these gates generated from nonlinear systems are called Chaogates and can be modeled as a function,

$$g ( x , y ; Δ , {X}_{0} , {X}_{T H R E S H O L D} ) = map ( {X}_{0} + x \cdot Δ + y \cdot Δ ) > {X}_{T H R E S H O L D} , \qquad ( 1 )$$

where, x, y∈{0,1} are the Boolean inputs, Δ, X₀, X_{THRESHOLD} are the encoding parameters that control the behavior of the Chaogate. The dynamics of the nonlinear system provides a nonlinear 1D to 1D map function, A denotes the change in the state due to the inputs being true or false, X₀, gives the bias when both inputs are false, and X_{THRESHOLD} gives the cut off between true and false output of the gate.

The core objective is to find values for the encoding parameters such that the outputs of the Chaogate replicate the behavior of the basic logic gates.

### Nonlinear Maps

Nonlinear maps are functions exhibiting complex, often chaotic behavior that are useful ways of modeling dynamical processes. In the context of logic gates, these maps play the important role of generating the dynamics needed to mimic the behavior of Boolean logic. In this work, three prototypical nonlinear systems were studied: the Logistic map, and the Lorenz and Duffing systems. All three systems can exhibit both regular and chaotic behavior depending on the parameter values, making them versatile test beds for the proposed algorithm. Each of these systems introduces distinct types of behavior that can be used to construct reconfigurable Chaogates

The Logistic map is a simple model for chaos given by the recursive equation,

$${x}_{n + 1} = a {x}_{n} ( 1 - {x}_{n} ) , \qquad ( 2 )$$

where a is a parameter that controls the behavior of the system and xₙ represents the state of the system at step n. The Logistic map can exhibit a range of behaviors from stable fixed points to fully chaotic dynamics, depending on the value of a. The algorithm was used to find suitable encoding to use the Logistic map as a logic gate across the values of a in the range 0 to 4, and study its efficacy.

The Lorenz system, originally derived to model atmospheric convection, is a set of three coupled first-order differential equations,

$$\frac{d x}{d t} = σ ( y - x ) , \frac{d y}{d t} = x ( ρ - z ) - y , \frac{d z}{dt} = x y - β z , \qquad ( 3 )$$

where σ, ρ, and β are system parameters, yielding the famous double-scroll chaotic attractor. Unless stated otherwise, the Lorenz system has parameters σ=10.0, ρ=28.0, β=8/3, and the dynamics are obtained by numerical integration using the Euler method, with time step equal to 0.001, over 1000 steps.

This system offers a rich range of dynamical behavior, and the three-dimensional dynamics allow for more complex control over the input-output relationship.

To use the Lorenz system as a one-dimensional mapping as necessitated by the Chaogate formulation, the encoded one-dimensional input was projected to the Lorenz system by setting initial state x=y=z=input, integrating it from initial time t=0 to final time t=1, and then projecting it back down by capturing the final x coordinate. This one-dimensional mapping is what is implied by the Lorenz system for the remainder of this disclosure.

Lastly, the Duffing oscillator system described by the second-order non-autonomous differential equation was used,

$$\frac{{d}^{2} x}{{dt}^{2}} + δ \frac{d x}{d t} + α x + β {x}^{3} = γ cos ( ω t ) , \qquad ( 4 )$$

where δ is the damping coefficient, α and β control the linear and nonlinear stiffness, and γ and ω are the amplitude and frequency of the driving force, respectively. Unless stated otherwise, the Duffing oscillator has parameters α=1.0, β=5.0, δ=0.02, γ=8.0, ω=0.5, and the dynamics is obtained by numerical integration using the Euler method, with time step equal to 0.001, over 1000 steps.

To use the Duffing system as a one-dimensional mapping as necessitated by the Chaogate formulation, the encoded one-dimensional input was projected to the Duffing system by setting initial state x=input, \dot{x}=0, integrating it from initial time t=0 to final time t=1, and then projecting it back down by capturing the final x coordinate. This one-dimensional mapping is what is implied by the Duffing system for the remainder of this disclosure.

It is important to note that the reduction of an N-dimensional continuous flow to a 1-dimensional map is not unique and can be done in several ways. The tent map like representation of the Lorenz system is derived by considering the local maxima of one of the flow variables. Other techniques include using the Poincare sections to reduce the output dimension. In this case, the high-dimensional system was simply projected down to one of the coordinates and that result used as a suitable 1-dimensional map for the analysis.

The choice and configuration of the nonlinear maps determine the complexity of the system, with more complex maps obtained from continuous-time higher-dimensional systems such as the Duffing and Lorenz oscillators, offering greater flexibility at the cost of higher computational overhead.

### Gradient Based Optimization

To optimize the parameters of the Chaogate to match the truth table of target logic gate, gradient based optimization can be utilized. This is an approach that is widely used in machine learning and numerical analysis and more popular recently as the technique for optimizing the large number of parameters in neural networks. The general goal in gradient based optimization is to minimize a loss function £ that measures the difference between the current output of the system and the desired output of the system. The optimization involves calculating the gradient of this loss function with respect to the tunable parameters of the system (Δ, X₀, X_{THRESHOLD} here) and then iteratively updating the parameters in the direction of negative gradient.

The use of gradient-based optimization enables efficient tuning of the nonlinear Chaogate, allowing it to accurately replicate the functionality of basic logic gates. This approach scales well with the complexity of the system, providing a flexible and efficient method for configuring Chaogates through controlled chaotic dynamics.

### Methodology

The output of the Chaogate has to be compared to the expected truth table of the target gate. The desired Boolean outputs for a gate G can be represented by a truth table,

$${T}_{G} = \{ {t}_{00} , {t}_{01} , {t}_{10} , {t}_{11} \} , \qquad ( 5 )$$

where t₀₀, t₀₁, t₁₀, t₁₁ ∈{0, 1} are the expected outputs for gate G acting on xy input combinations.

Tuning the gates with Boolean outputs through gradient optimization that expects differentiable parameters is non-trivial, and requires some novelty. First, modify the Chaogate equation (1) from an inequality to a continuous function,

$$g ( x , y ; Δ , {X}_{0} , {X}_{T H R E S H O L D} ) = map ( {X}_{0} + x \cdot Δ + y \cdot Δ ) - {X}_{T H R E S H O L D} . \qquad ( 6 )$$

Recall that x, y∈{0,1} are the Boolean inputs, and Δ, X₀, X_{THRESHOLD} are the encoding parameters that control the behavior of the Chaogate. The 1-d to 1-d map function, equivalent to that in Eq. (1), is provided by the dynamics of the nonlinear systems described above. The specific method of construction of the map function in Eq. (6) above, from the higher-dimensional continuous flows given in Eqs. (3)-(4), is specified in the Nonlinear maps Section above.

The output of this function can be passed to a sigmoid function to get a differentiable probability,

$$\begin{matrix}{\hat{t}}_{xy} = σ ( g ( x , y ; Δ , {X}_{0} , {X}_{THRESHOLD} ) ) \\ = \frac{1}{1 + exp ( - g ( x , y ; Δ , {X}_{0} , {X}_{THRESHOLD} ) )}\end{matrix} , \qquad ( 7 )$$

where σ(⋅) is the sigmoid function ensuring a differentiable output. Sigmoid is not a probability density function since it integrates to infinity. But it corresponds to the cumulative probability function of the Logistic distribution. Given that the values lie in the interval [0, 1], it can be interpreted as a confidence index, and intuitively, as probability.

Inspired by its usage in classification problems, binary cross entropy can be used to compare the differentiable probability from Eq. (7) to the Boolean truths from the truth table shown in Eq. (5).

For each pair (x, y),

$${ℒ}_{xy} = - {t}_{xy} log ( {\hat{t}}_{xy} ) - ( 1 - {t}_{xy} ) log ( 1 - {\hat{t}}_{xy} ) , \qquad ( 8 )$$

and the total loss is obtained by simply averaging over all input combinations,

$$ℒ ( Δ , {X}_{0} , {X}_{THRESHOLD} ) = \frac{1}{4} {\sum }_{( x , y ) ∈ {\{ 0 , 1 \}}^{2}} {ℒ}_{xy} , \qquad ( 9 )$$

which is differentiable with respect to our desired tunable parameters, Ω={Δ, X₀, X_{THRESHOLD}}, allowing the use of standard gradient based optimization techniques as though the Chaogate was a neural network and Ω its weights and biases.

So the parameters can be updated iteratively using methods like stochastic gradient descent (SGD),

$$ω ← ω - η \frac{\partial ℒ}{\partial ω} , \qquad ( 10 )$$

for all ω∈Ω, where η is the learning rate.

After the optimization process is run till convergence, the resulting parameters

$${Ω}^{*} = \{ {Δ}^{*} , {X}_{0}^{*} , {X}_{THRESHOLD}^{*} \}$$

can be interpreted as optimal parameters for configuring the Chaogate to behave like the target gate.

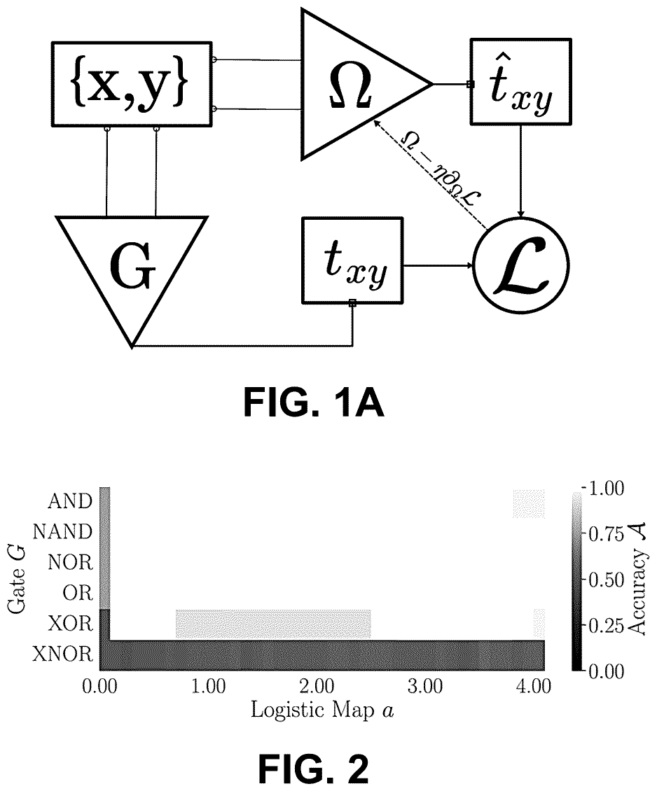

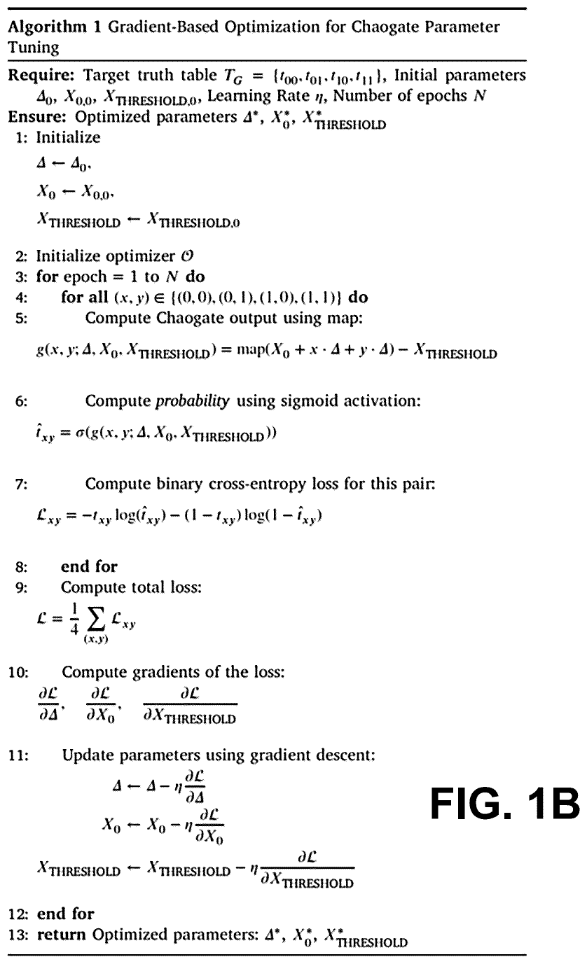

FIG. 1A is a schematic diagram illustrating an example of the gradient based optimization of Chaogates and FIG. 1B illustrates an example of an algorithm showing gradient based optimization for Chaogate parameter tuning. The parameters of the Chaogate are tuned by gradient descent on a binary cross entropy loss as though the Chaogate is a neural network classifying the binary input data into two classes. {x, y} are the Boolean inputs to the binary gates, G is the true logic gate as defined by the truth table, Ω denotes the tunable parameters of the Chaogate, t_{xy} and \hat{t}_{xy} and the target and predicted outputs respectively that are passed into the binary cross entropy loss function L. The dashed line indicates the parameter update from gradient optimization of the loss.

In summary, this optimization scheme as outlined in FIG. 1A, and detailed in the algorithm of FIG. 1B, comprises tuning the parameters of the Chaogate via gradient descent on a binary cross-entropy loss. This essentially treats the Chaogate as a neural network classifier that predicts True or False depending on the inputs.

### Results

The results of tuning Chaogates into the standard Boolean gates are presented for all three dynamical systems. The three different systems show drastic differences in how variations in their configurations affect their ability to effectively encode the various gates. All instances were trained for 5000 epochs with a learning rate η of 10⁻³. More optimal hyperparameter selection is clearly possible, but it is opted for simple consistency for comparability in this proof-of-concept work.

FIG. 2 illustrates an example of tuning Chaogates with the Logistic map across configurable parameter a. All gates other than XNOR achieve 100% accuracy rapidly across most of the sweep. The efficacy of the gate is largely independent of the configuration indicating the rapid convergence of to an optimal Chaogate configurations and relatively low sensitivity to initialization. All results presented are averaged across 10 initializations. As shown in FIG. 2, the Logistic map is easy to configure across the parameter space and shows rapid convergence, giving us perfect logic gates across most of the sweep for all gates but XNOR. Similar results are also found for the 2-dimensional discrete Hénon Map as shown in Appendix A below. This indicates the broader scope of the method and its relevance to a wider class of discrete dynamical systems, including higher-dimensional maps.

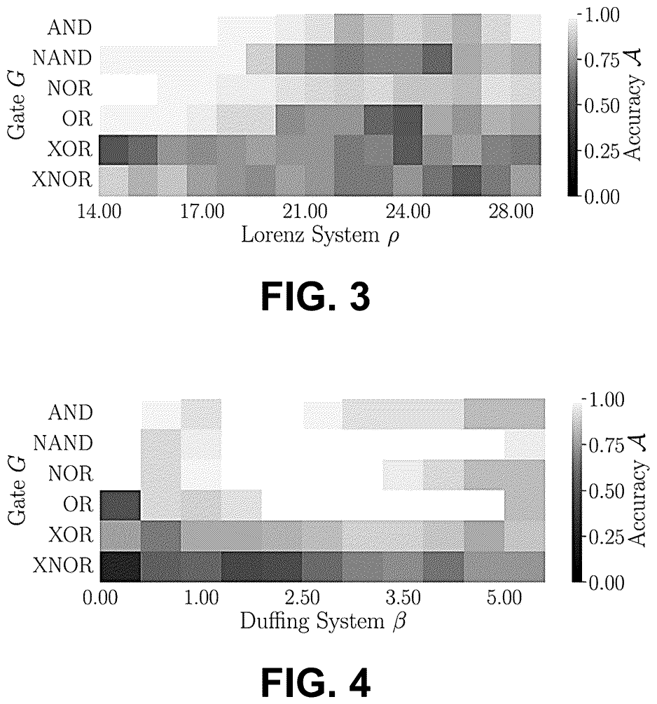

FIG. 3 illustrates an example of tuning Chaogates with the Lorenz system across configurable parameter ρ. This sweep is much more feature rich than for the Logistic map. There is a far greater dependence of loss on configuration indicating the chance of non-convergence at 5000 epochs in some configurations and high sensitivity to initializations. All results presented are averaged across 10 initializations. As shown in FIG. 3, the Chaogate using the Lorenz system is harder to configure and slower due to the numerical integration needed at every evaluation. Even though it is unlikely that they have full convergence in 5000 epochs, regions were found where perfect logic gate behavior was obtained for universal gates.

FIG. 4 illustrates an example of tuning Chaogates with the Duffing system across configurable parameter β. This sweep is much more feature rich than for the Logistic map. Duffing oscillator occupies a middle ground between the lower-stability of Lorenz and lower-expressivity of Logistic map. All results presented are averaged across 10 initializations. As shown in FIG. 4, Chaogates using the Duffing system serve as a middle ground between those using the Logistic map and the Lorenz system. It has a much larger pocket of perfect logic gate behavior despite having regions of nonconvergence at 5000 epochs.

The under-performance of the Chaogates on XNOR gates is due to the nature of the encoding. This is not a major concern since XNOR can be easily captured using the universal gates that Chaogates do mimic well or by changing the encoding if low gate count is a priority. In fact, simply separating the shared Δ parameter to Δx and Δy would give full coverage of the standard gates. In this work, it has chosen to present the conventional encoding for ease of comparison with prior work. Additionally, in Appendix B below, the results obtained using the modification in encoding given above are shown. Clearly, a simple encoding modification can give perfect accuracy for XNOR as well, for the Logistic map.

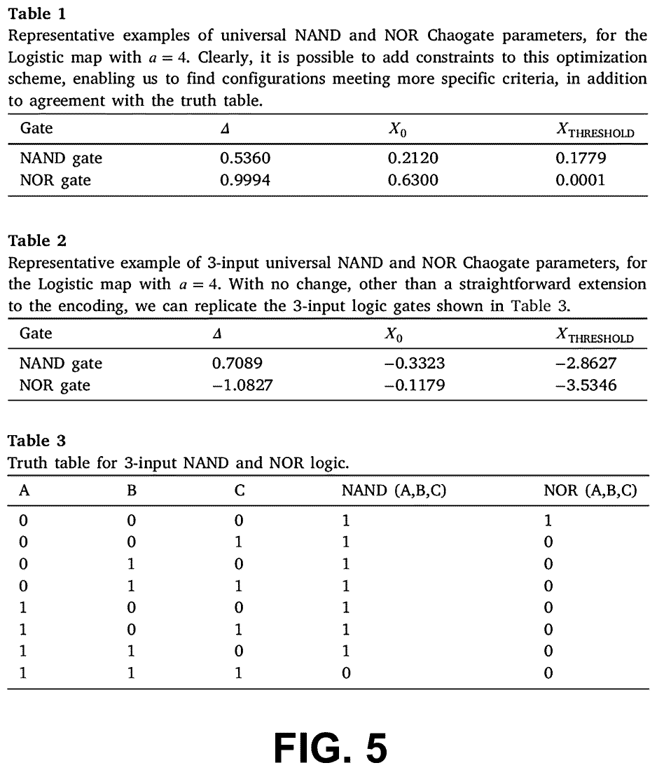

The gradient based tuning methodology also gives the ability to include soft and hard constraints to the optimization to prioritize configurations that meet certain criteria. Table 1 of FIG. 5 showcases an instance of Chaogates configured for the Logistic map with values of the state variables that are bounded in (0,1) by wrapping the Chaogate parameters in a sigmoid function during optimization and treating the sigmoid of the parameter as the state variables.

Eq. (6), which was used for encoding, can be generalized to treat cases beyond binary inputs. Configurations can be found for multi-input gates having larger truth tables by altering the equation to, e.g.,

$$g ( X ; Δ , {X}_{0} , {X}_{THRESHOLD} ) = map ( {X}_{0} + {\sum }_{x ∈ X} x \cdot Δ ) - {X}_{THRESHOLD} , \qquad ( 11 )$$

where |X| is the number of inputs to the gate. This encoding is valid as long as the gate is permutation invariant to its inputs, as is the case with the standard logic gates. This was illustrated by tuning the Logistic map to yield 3-input NAND and NOR gates in Table 2 of FIG. 5, replicating the truth table shown in Table 3 of FIG. 5.

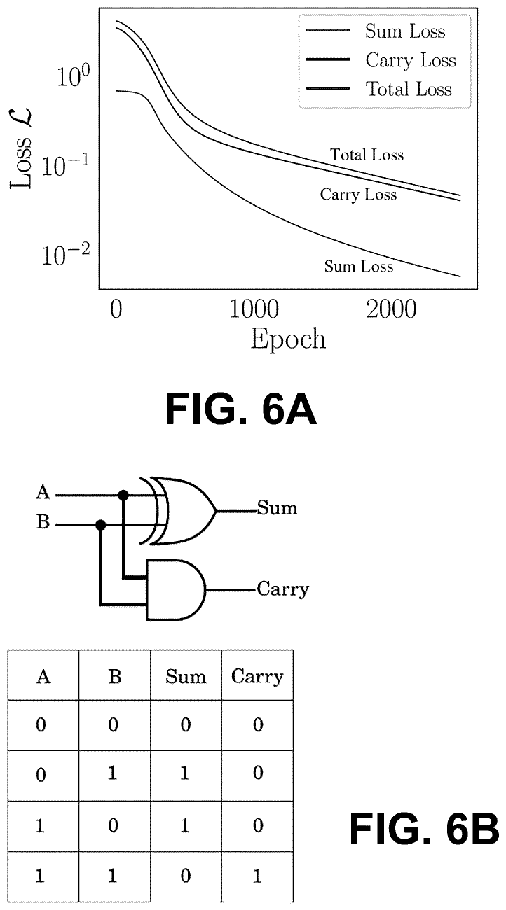

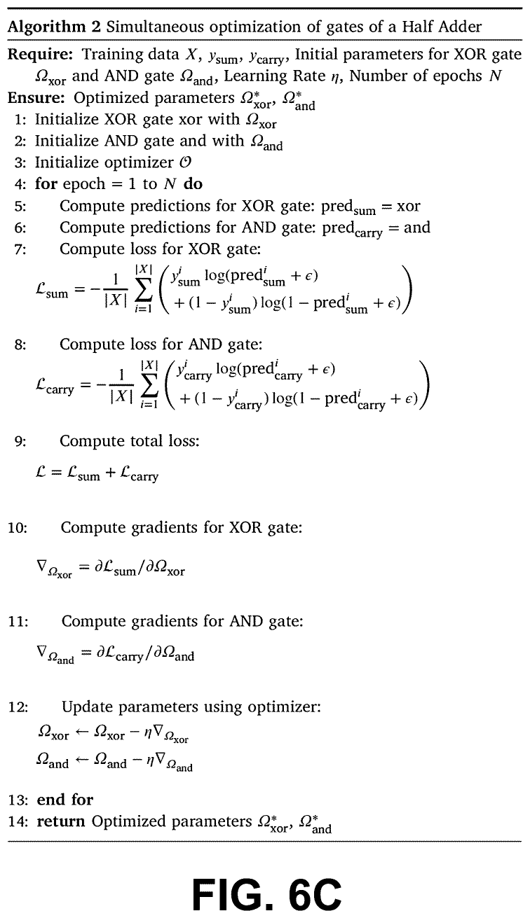

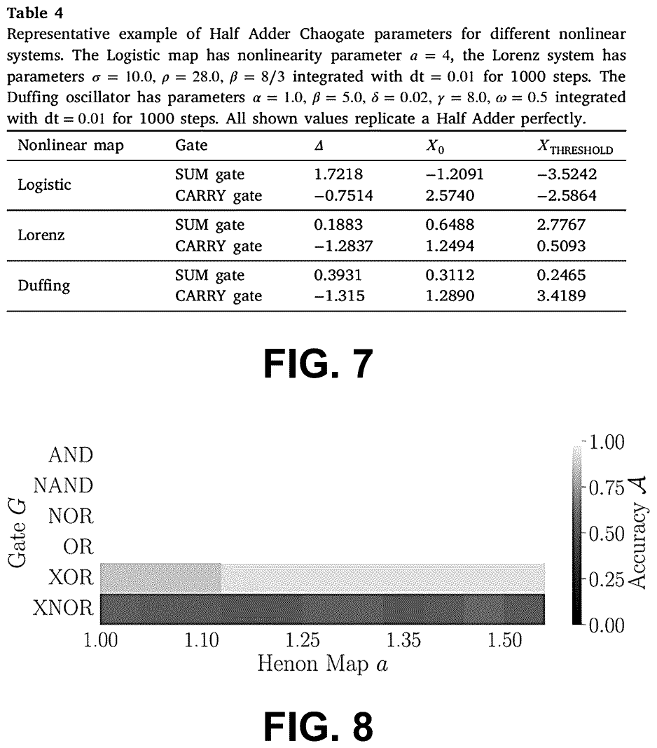

Extension to simultaneous tuning of all gates in a logic circuit. This technique of tuning the Chaogate can also be scaled to simultaneously tune an arbitrary number of gates to get the desired output from logic circuits. For instance, the SUM and CARRY operations of a Half Adder can be trained simultaneously by separately scoring the loss functions of the two gates and outputs. FIGS. 6A and 6B illustrate an example of simultaneous tuning of a Half Adder circuit. The sum and carry gates of the Half Adder are tuned simultaneously as described in the algorithm of FIG. 6C. FIG. 6A shows the loss decrease over training for Logistic map Chaogates, the losses for the 2 logical outputs are used to find the best Chaogate configuration for the circuit and truth table shown in FIG. 6B. The gate parameters are initialized randomly from the normal distribution. This allows us to find optimal values of all the gates in tandem so that they work well with each other (see Table 4 of FIG. 7).

All algorithms were implemented in Python using JAX autodifferentiation framework with Optax for gradient processing and optimization and Equinox Neural Network library. The AdaBelief optimizer from Optax was used for its stability and fast convergence.

### Appendix A. Two-Dimensional Hénon Map

The two-dimensional discrete Hénon map was also explored, and is defined as

$${x}_{n + 1} = 1 - {ax}_{n}^{2} + {y}_{n} , \qquad ( 12 )$$

$${y}_{n + 1} = {bx}_{n} .$$

where the x value of the system was used to obtain the 1-dimensionalized map, fixing b=0.3, y=x=input.

As evident from FIG. 8, this 2-dimensional system yields results that are very similar to the 1-dimensional Logistic map. This strongly suggests that the simplicity of discrete maps, even when higher dimensional, still lends itself to fast convergence and consistent performance across the sweep.

### Appendix B. Resolving XNOR

To mitigate the lack of accuracy in configuring the conventional Chaogate to XNOR logic, a new encoding was explored:

$$g ( x , y ; Δ , {X}_{0} , {X}_{T H R E S H O L D} ) = map ( {X}_{0} + x \cdot {Δ}_{x} + y \cdot {Δ}_{y} ) - {X}_{T H R E S H O L D} , \qquad ( 13 )$$

where, as before, x, y∈{0,1} are the Boolean inputs, and X₀, X_{THRESHOLD} are the encoding parameters that control the behavior of the Chaogate. The map is a nonlinear 1-d to 1-d function obtained from the dynamics of the nonlinear system, as given earlier in Eq. (6). Δx and Δy are determined by the input x and y respectively on the gate, and this is the modification that was made to Eq. (6) to achieve XNOR coverage (i.e., the conventional encoding given by Eq. (6) is the constrained case with Δx=Δy=4).

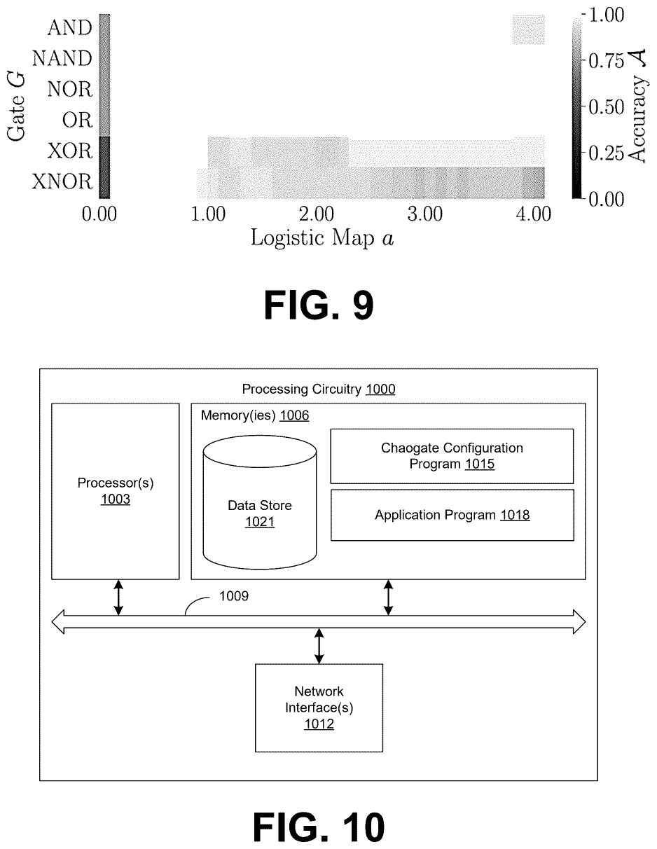

With this simple modification in input encoding, we can find that the Logistic map (cf. FIG. 9) achieves perfect accuracy for all gates within the training period.

FIG. 10 is a schematic diagram illustrating an example of a processing circuitry 1000 that can be used for chaogate configuration and optimization, in accordance with various embodiments of the present disclosure. The processing circuitry 1000 can comprise one or more computing/processing device such as, e.g., a smartphone, tablet, computer, controller, etc. The processing circuitry 1000 can include at least one processor circuit, for example, having a processor 1003 and a memory 1006, both of which are coupled to a local interface 1009. To this end, each processing circuitry 1000 may comprise, for example, at least one server computer or like device, which can be utilized in a cloud based environment. The local interface 1009 may comprise, for example, a data bus with an accompanying address/control bus or other bus structure as can be appreciated.

In some embodiments, the processing circuitry 1000 can include one or more network interfaces 1012. The network interface 1012 may comprise, for example, a wireless transmitter, a wireless transceiver, and/or a wireless receiver. The network interface 1012 can communicate to a remote computing/processing device or other components using a Bluetooth, WiFi, or other appropriate wireless protocol. As one skilled in the art can appreciate, other wireless protocols may be used in the various embodiments of the present disclosure. The network interface 1012 can also be configured for communications through wired connections.

Stored in the memory 1006 are both data and several components that are executable by the processor(s) 1003. In particular, stored in the memory 1006 and executable by the processor 1003 can be a chaogate configuration application 1015 which can reconstruct ECG signal from IMU signals as disclosed herein, and potentially other applications 1018. In this respect, the term “executable” means a program file that is in a form that can ultimately be run by the processor(s) 1003. Also stored in the memory 1006 may be a data store 1021 and other data. In addition, an operating system may be stored in the memory 1006 and executable by the processor(s) 1003. It is understood that there may be other applications that are stored in the memory 1006 and are executable by the processor(s) 1003 as can be appreciated.

Examples of executable programs may be, for example, a compiled program that can be translated into machine code in a format that can be loaded into a random access portion of the memory 1006 and run by the processor(s) 1003, source code that may be expressed in proper format such as object code that is capable of being loaded into a random access portion of the memory 1006 and executed by the processor(s) 1003, or source code that may be interpreted by another executable program to generate instructions in a random access portion of the memory 1006 to be executed by the processor(s) 1003, etc. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1003 may represent multiple processors 1003 and/or multiple processor cores, and the memory 1006 may represent multiple memories 1006 that operate in parallel processing circuits, respectively. In such a case, the local interface 1009 may be an appropriate network that facilitates communication between any two of the multiple processors 1003, between any processor 1003 and any of the memories 1006, or between any two of the memories 1006, etc. The local interface 1009 may comprise additional systems designed to coordinate this communication, including, for example, ultrasound or other devices. The processor 1003 may be of electrical or of some other available construction.

Although the chaogate configuration 1015, and other various applications 1018 described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the chaogate configuration application 1015, that comprises software or code can be embodied in any non-transitory computer-readable medium for use by or in connection with an instruction execution system such as, for example, a processor 1003 in a computer system or other system. In this sense, the logic may comprise, for example, statements including instructions and declarations that can be fetched from the computer-readable medium and executed by the instruction execution system. In the context of the present disclosure, a “computer-readable medium” or “machine-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the chaogate configuration application 1015, may be implemented and structured in a variety of ways. For example, one or more applications described may be implemented as modules or components of a single application. For example, the chaogate configuration application 1015 can include a wide range of modules such as, e.g., an initial model or other modules that can provide specific functionality for the disclosed methodology. Further, one or more applications described herein may be executed in shared or separate computing/processing devices or a combination thereof. For example, a plurality of the applications described herein may execute in the same processing circuitry 1000, or in multiple computing/processing devices in the same computing environment. To this end, each processing circuitry 1000 may comprise, for example, at least one server computer or like device, which can be utilized in a cloud-based environment.

### DISCUSSION

In this disclosure, the feasibility of configuring nonlinear systems as logic gates using gradient-based optimization was demonstrated. A range of chaotic systems was effectively tuned to yield Chaogates, in an automated fashion, accurately replicating the behavior of standard Boolean gates.

By transforming the Chaogate configuration problem into one that can be optimized through gradient-based methods, decades of research on efficient optimization techniques from machine learning algorithms were leveraged. Opting to apply this optimization directly to the Chaogate, rather than using a neural network to discover configurations, significantly reduces the computational cost of finding these configurations. This approach essentially treats the Chaogate like a neural network, with the tunable parameters being the configuration parameters (Δ, X₀, X_{THRESHOLD}) specific to the encoding.

This optimization scheme was shown to allow it to be selective about the kinds of configurations that can be prioritized by using weak constraints in the loss function. This can also be further enforced into hard constraints by changing the encoding or optimization scheme. Further, the proposed encoding was demonstrated to be general and can be used on gates of arbitrary input size, as long as the gates are permutation invariant to the inputs. In addition, a preliminary algorithmic extension of this technique was given for configuring all the gates in a logic circuit simultaneously.

The comparison of different nonlinear maps in Chaogate configurations lends credence to our intuition of the complexities of these maps. The Logistic map is simple and shows strong performance in tuning for basic gate operations and achieves fast convergence across the parameter range. The Lorenz system provides a richer chaotic structure allowing it to do slightly better in regimes where the Logistic map under-performs but at the price of increased computational complexity and slower convergence. The Duffing oscillator occupies a middle ground between them. The Logistic map performed well above the estimation during unconstrained optimization and achieved perfect accuracy almost throughout the sweep. This suggests that the necessary conditions for the map to encode logic gates are fairly minimal and, due to its simplicity, the gates can be tuned to convergence in almost every case.

Beyond its application for Chaogates, this configuration discovery technique is highly versatile and can be employed across various paradigms. It can optimize conventional computing systems such as transistors, and is also well-suited for neuromorphic systems, where the inherent nonlinearity of chaotic dynamics makes it an ideal model for neural circuits. While this proof of concept is promising, there are challenges to scaling this to more complex circuits. As the number of gates increases, the current optimization scheme does not scale as naturally as a conventional multilayer perceptron neural network would. And the nature of in tandem optimization can lead to slower convergence times. Additionally, this technique can be combined with genetic algorithms or reinforcement learning style techniques to add to circuit discovery in tandem with gate reconfiguration.

In summary, this disclosure has demonstrated the potential of using gradient-based optimization to configure Chaogates to replicate traditional deterministic logic gates, addressing the difficulty of navigating the parameter spaces of chaotic systems for Chaogate configuration. A pathway has been provided for automating the discovery of parameters across nonlinear computational devices, opening avenues to applications in both more traditional logic circuits and in neuromorphic computation. With further advancements in optimization techniques and integration with other algorithmic approaches, this method holds promise for transforming the design and implementation of nonlinear logic systems.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for chaogate configuration as a Boolean logic gate, comprising:
initializing chaogate parameters of a chaogate;
determining binary cross-entropy losses based upon outputs of the chaogate with the initialized chaogate parameters and a truth table of desired Boolean outputs;
adjusting chaogate parameters using stochastic gradient descent, the chaogate parameters negatively adjusted based upon a total loss and a defined learning rate;
determining binary cross-entropy losses based upon outputs of the chaogate with the adjusted chaogate parameters and the truth table;
repeating the adjustment of the chaogate parameters using stochastic gradient descent and the determination of the binary cross-entropy losses based upon outputs of the chaogate with the adjusted chaogate parameters and the truth table for a defined number of iterations or until the total loss is less than a defined threshold; and
implementing a chaogate with the adjusted chaogate parameters.

2. The method of claim 1, wherein the total loss is an average of all of the determined binary cross-entropy losses.

3. The method of claim 1, comprising determining a negative gradient descent adjustment for each of the chaogate parameters based upon the total loss and the defined learning rate.

4. The method of claim 1, wherein the outputs of the chaogate are passed through a sigmoid function prior to determining the binary cross-entropy losses.

5. The method of claim 1, wherein the chaogate is a Logistic map, a Lorenz system, or a Duffing oscillator system.

6. The method of claim 5, wherein the Lorenz system or the Duffing oscillator system is defined as a one-dimensional (1D) to 1D system.

7. The method of claim 1, wherein the Boolean logic gate is an AND gate, a NAND gate, a NOR gate, an OR gate, an XOR gate, or an XNOR gate.

8. The method of claim 1, wherein implementing the chaogate comprises reconfiguring an existing chaogate with the adjusted chaogate parameters.

9. A system for chaogate configuration as a Boolean logic gate, comprising:
processing circuitry comprising a processor and memory; and
machine-readable instructions stored in the memory that, when executed by the processor, cause the processing circuitry to at least:
initialize chaogate parameters of a chaogate;
determine binary cross-entropy losses based upon outputs of the chaogate with the initialized chaogate parameters and a truth table of desired Boolean outputs;
adjust chaogate parameters using stochastic gradient descent, the chaogate parameters negatively adjusted based upon a total loss and a defined learning rate;
determine binary cross-entropy losses based upon outputs of the chaogate with the adjusted chaogate parameters and the truth table;
repeat the adjustment of the chaogate parameters using stochastic gradient descent and the determination of the binary cross-entropy losses based upon outputs of the chaogate with the adjusted chaogate parameters and the truth table for a defined number of iterations or until the total loss is less than a defined threshold; and
implement a chaogate with the adjusted chaogate parameters.

10. The system of claim 9, wherein the total loss is an average of all of the determined binary cross-entropy losses.

11. The system of claim 9, wherein, when executed, the machine-readable instructions cause the processing circuitry to at least:
determine a negative gradient descent adjustment for each of the chaogate parameters based upon the total loss and the defined learning rate.

12. The system of claim 9, wherein the outputs of the chaogate are passed through a sigmoid function prior to determining the binary cross-entropy losses.

13. The system of claim 9, wherein the chaogate is a Logistic map, a Lorenz system, or a Duffing oscillator system.

14. The system of claim 13, wherein the Lorenz system or the Duffing oscillator system is defined as a one-dimensional (1D) to 1D system.

15. The system of claim 9, wherein the Boolean logic gate is an AND gate, a NAND gate, a NOR gate, an OR gate, an XOR gate, or an XNOR gate.

16. The system of claim 9, wherein implementing the chaogate comprises reconfiguring an existing chaogate with the adjusted chaogate parameters.

17. The system of claim 9, wherein the processing circuitry comprises a computing device.
